(19) United States
(12) Patent Application Publication
(10) Pub. No.: US 2023/0196526 A1
(43) Pub. Date: Jun. 22, 2023

(54) DYNAMIC CONVOLUTIONS TO REFINE IMAGES WITH VARIATIONAL DEGRADATION

(71) Applicant: MediaTek Inc., Hsinchu (TW)

(72) Inventors: Yu-Syuan Xu, Hsinchu (TW); Yu Tseng, Hsinchu (TW); Shou-Yao Tseng, Hsinchu (TW); Hsien-Kai Kuo, Hsinchu (TW); Yi-Min Tsai, Hsinchu (TW)

(21) Appl. No.: 17/552,912

(22) Filed: Dec. 16, 2021

(51) Int. Cl. G06T 5/50; G06T 5/00; G06N 3/04

(52) U.S. Cl. CPC G06T 5/50; G06T 5/001; G06N 3/04

(57) ABSTRACT

A system stores parameters of a feature extraction network and a refinement network. The system receives an input including a degraded image concatenated with a degradation estimation of the degraded image; performs operations of the feature extraction network to apply pre-trained weights to the input to generate feature maps; and performs operations of the refinement network including a sequence of dynamic blocks. One or more of the dynamic blocks dynamically generates per-grid kernels to be applied to corresponding grids of an intermediate image output from a prior dynamic block in the sequence. Each per-grid kernel is generated based on the intermediate image and the feature maps.

### TECHNICAL FIELD

Embodiments of the invention relate to neural network operations for image quality enhancement.

### BACKGROUND

Deep Convolutional Neural Networks (CNNs) have been widely adopted for image processing such as image refinement and super-resolution. The CNNs have been used to restore an image degraded by blur, noise, low resolution, and the like. The CNNs have been shown to be effective in solving single image super-resolution (SISR) problems, where a high-resolution (HR) image is reconstructed from a low-resolution (LR) image.

Some CNN-based methods have the assumption that a degraded image is subject to one fixed combination of degrading effects, e.g., blurring and bicubic down-sampling. These methods have limited capability in handling images where the degrading effects vary from one image to another. These methods also cannot handle an image that has one combination of degrading effects in one region and another combination of degrading effects in another region of the same image.

Another approach is to train an individual network for each combination of degrading effects. For example, if an image is degraded by three different combinations of degrading effects: bicubic down-sampling, bicubic down-sampling and noise, and direct down-sampling and blurring, three networks are trained to handle these degradations.

Therefore, there is a need for improving the existing methods for refining an image that is subject to variational degradation effects.

### SUMMARY

In one embodiment, a method is provided for image refinement. The method includes the steps of: receiving an input including a degraded image concatenated with a degradation estimation of the degraded image; performing feature extraction operations to apply pre-trained weights to the input to generate feature maps; and performing operations of a refinement network that includes a sequence of dynamic blocks. One or more of the dynamic blocks dynamically generates per-grid kernels to be applied to corresponding grids of an intermediate image output from a prior dynamic block in the sequence. Each per-grid kernel is generated based on the intermediate image and the feature maps.

In another embodiment, a system includes memory to store parameters of a feature extraction network and a refinement network. The system further includes processing hardware coupled to the memory. The processing hardware is operative to: receive an input including a degraded image concatenated with a degradation estimation of the degraded image; perform operations of the feature extraction network to apply pre-trained weights to the input to generate feature maps; and perform operations of the refinement network that includes a sequence of dynamic blocks. One or more of the dynamic blocks dynamically generates per-grid kernels to be applied to corresponding grids of an intermediate image output from a prior dynamic block in the sequence. Each per-grid kernel is generated based on the intermediate image and the feature maps.

Other aspects and features will become apparent to those ordinarily skilled in the art upon review of the following description of specific embodiments in conjunction with the accompanying figures.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 is a diagram illustrating a framework of a Unified Dynamic Convolutional Network for Variational Degradation (UDVD) according to one embodiment.

FIG. 2 illustrates an example of a residual block according to one embodiment.

FIG. 3 is a block diagram illustrating a dynamic block according to one embodiment.

FIG. 4 illustrates two types of dynamic convolutions according to some embodiments.

FIG. 5 is a diagram illustrating multistage loss computations according to one embodiment.

FIG. 6 is a flow diagram illustrating a method for image refinement according to one embodiment.

FIG. 7 is a block diagram illustrating a system operative to perform image refinement operations according to one embodiment.

### DETAILED DESCRIPTION

In the following description, numerous specific details are set forth. However, it is understood that embodiments of the invention may be practiced without these specific details. In other instances, well-known circuits, structures, and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

Embodiments of the invention provide a framework of a Unified Dynamic Convolutional Network for Variational Degradation (UDVD). The UDVD performs single image super-resolution (SISR) operations for a wide range of variational degradation. Furthermore, the UDVD can also restore image quality from blurring and noise degradation. The variational degradation can occur inter-image and/or intra-image. Inter-image variational degradation is also known as cross-image variational degradation. For example, a first image may be low resolution and blurred, and a second image may be noisy. Intra-image variational degradation is degradation with spatial variations in an image. For example, one region in an image may be blurred and another region in the same image may be noisy. The UDVD can be trained to enhance the quality of images that suffer from inter-image and/or intra-image variational degradation. The UDVD incorporates dynamic convolution, which provides more flexibility in handling different degradation variations than standard convolution. In SISR with a non-blind setting, the UDVD has demonstrated the effectiveness on both synthetic and real images.

Dynamic convolutions have been an active area in neural network research. Brabandere et al. “Dynamic filter networks,” in Proc. Conf. Neural Information Processing Systems (NIPS) 2016, describes a dynamic filter network that dynamically generates filters conditioned on an input. Dynamic filter networks are adaptive to input content and therefore offers increased flexibility.

The UDVD generates dynamic kernels based on the concept of dynamic filter networks with modifications. The dynamic kernels disclosed herein adapt to not only image contents but also diverse variations of degrading effects. The dynamic kernels are effective in handling inter-image and intra-image variational degradation.

The standard convolution uses kernels that are learned from training. Each kernel is applied to all pixel locations. In contrast, the dynamic convolution disclosed herein uses per-grid kernels that are generated by a parameter-generating network. Moreover, the kernels of standard convolution are content-agnostic which are fixed after training is completed. In contrast, the dynamic convolution kernels are content-adaptive and can adapt to different inputs during inference. Due to these properties, the dynamic convolution is a better alternative to the standard convolution in handling variational degradation.

In the following description, two types of dynamic convolutions are disclosed. Moreover, multistage losses are integrated to gradually refine images throughout consecutive dynamic convolutions. Extensive experiments show that the UDVD achieves favorable or comparable performance on both synthetic and real images.

In a practical use case, degrading effects such as blurring, noise, and down-sampling can simultaneously occur. The degradation process is formulated as:

I_{LR}=(I_{HR}⊗k)↓ₛ+n, (1)

where I_{HR} and I_{LR} represent high resolution (HR) and low resolution (LR) images, respectively, k represents a blur kernel, n represents additive noise. Equation (1) indicates that the LR image is equal to the HR image convolved with a blur kernel, downsampled with a scale factor s, and plus noise. An example of the blur kernel is the Isotropic Gaussian blur kernel. An example of additive noise is the additive white Gaussian noise (AWGN) with covariance (noise level). An example of downsampling is the bicubic downsampler. Other degradation operators may also be used to synthesize realistic degradations for SISR training. For real images, a search on degradation parameters is performed area by area to obtain visually satisfying results. In this disclosure, a non-blind setting is adopted. Any degradation estimation methods can be prepended to extend the disclosed method to a blind setting.

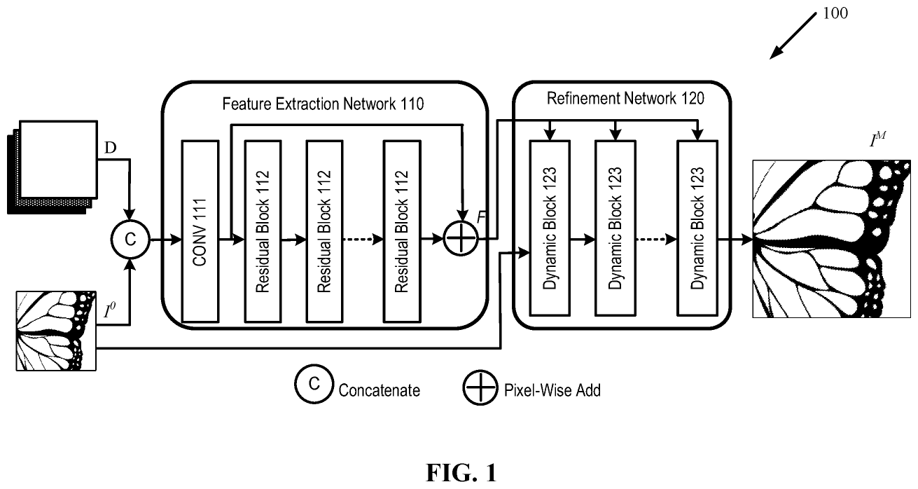

FIG. 1 is a diagram illustrating a UDVD framework 100 according to one embodiment. The framework 100 includes a feature extraction network 110 and a refinement network 120. The feature extraction network 110 operates to extract high-level features of a low-resolution input image (also referred to as a degraded image). The degraded image may contain variational degradation. The refinement network 120 learns to enhance and up-sample the degraded image based on the extracted high-level features. The output of the refinement network 120 is a high-resolution image.

The degraded image (denoted as I⁰) is concatenated with a degradation map (D). The degradation map D, also referred to as a degradation estimation, may be generated based on known degradation parameters in the degraded image; e.g., a known blur kernel and a known noise level σ. For example, the blur kernel may be projected to a t-dimensional vector by using the principal component analysis (PCA) technique. An extra dimension of noise level σ is concatenated to the t-dimensional vector to obtain a (1+t) vector. The (1+t) vector is then stretched to get a degradation map D of size (1+t)×H×w.

The feature extraction network 110 includes an input convolution 111 and N residual blocks 112. The input convolution 111 is performed on the degraded image (I⁰) concatenated with the degradation map (D). The convolution result is sent to the N residual blocks 112, and is added to the output of the N residual blocks 112 to generate feature maps (F).

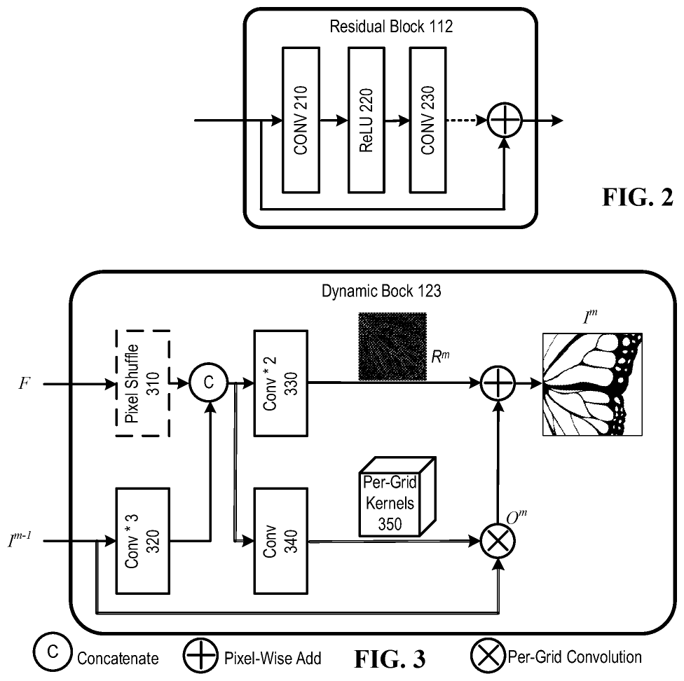

FIG. 2 illustrates an example of the residual block 112 according to one embodiment. Each residual block 112 performs operations of convolutions 210, rectified linear units (ReLU) 220, and convolutions 230. The output of the residual block 112 is the pixel-wise sum of the input to the residual block 112 and the output of the convolutions 230. As a non-limiting example, the kernel size of each convolution layer may be set to 3×3, and the number of channels may be set to 128.

The refinement network 120 includes a sequence of M dynamic blocks 123 to perform feature transformation. Each dynamic block 123 receives the feature maps (F) as one input. In one embodiment, the dynamic block 123 is extended to perform upsampling with an upsampling rate r. Each dynamic block 123 can learn to upsample and reconstruct the variationally degraded image.

FIG. 3 is a block diagram illustrating the dynamic block 123 according to one embodiment. It is understood that the dimensions of the kernels and the channels described below are non-limiting. Each dynamic block m receives the feature maps (F) and an image I^{m-1} as input (m=1, . . . , M). For the first dynamic block in the sequence of M dynamic blocks, the image I^{m-1} is the degraded image (I⁰) at the input of the framework 100. For the subsequent dynamic blocks in the sequence of M dynamic blocks, the image I^{m-1} is an intermediate image output from the prior dynamic block in the sequence. In the example of a dynamic block m, the image I^{m-1} is sent to CONV*3 320, which includes three 3×3 convolution layers with 16, 16, and 32 channels, respectively. The feature maps (F) from the feature extraction network 110 may optionally go through the operations of pixel shuffle 310. The output of the pixel shuffle 310 and the CONV*3 320 are concatenated and then forwarded to two paths.

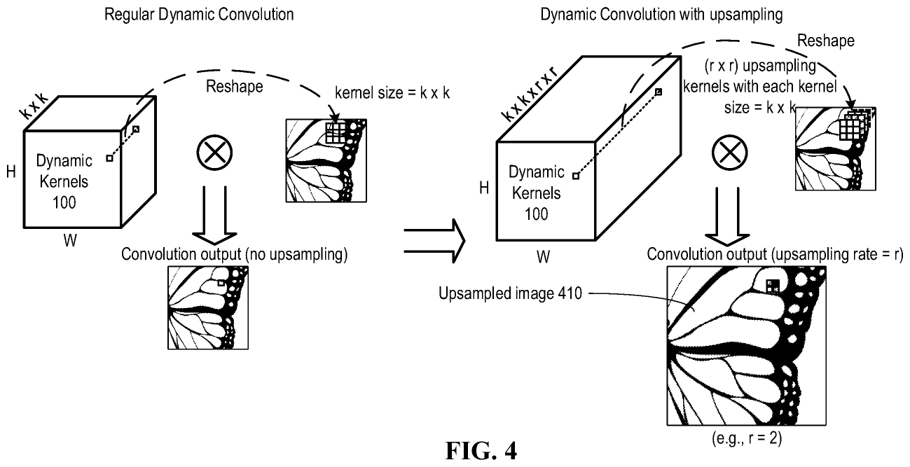

Each dynamic block 123 includes a first path and a second path. The first path predicts dynamic kernels 350 and then performs dynamic convolution by applying the dynamic kernels 350 to the image I^{m-1}. The dynamic convolution can be regular or upsampling. An example of the different types of dynamic convolutions is provided in connection with FIG. 4. Different dynamic blocks 123 may perform different types of dynamic convolutions. The second path generates a residual image for enhancing high-frequency details by using standard convolutions. The output of the first path and the output of the second path are combined by pixel-wise additions.

In FIG. 3, the lower portion indicated by double lines illustrated the first path. The first path includes a 3×3 convolution layer 340 to predict and generate the dynamic kernels 350. The generated dynamic kernels 350 are then applied to I^{m-1} to perform dynamic convolutions to generate an output O^{m}. In one embodiment, each dynamic kernel 350 is a per-grid kernel. The per-grid kernels 350 are to be applied to corresponding grids of I^{m-1} (m=1, . . . , M). Each per-grid kernel m is generated based on I^{m-1} and the feature maps F. Each corresponding grid contains one or more image pixels sharing and using the same per-grid kernel.

The second path contains two 3×3 convolution layers (shown as CONV*2 330) with 16 and 3 channels, respectively, to generate a residual image R^{m} for enhancing high-frequency details. The residual image R^{m} is then added to the output of dynamic convolution O^{m} to generate an image I^{m}. A sub-pixel convolution layer may be used to align the resolutions between the two paths.

FIG. 4 illustrates two types of dynamic convolutions according to some embodiments. The first type is the regular dynamic convolution, which is used when input resolution is the same as output resolution. The second type is the dynamic convolution with upsampling, which integrates upsampling into the dynamic convolution. Referring to the example in FIG. 3, the dynamic kernels 350 may be for regular dynamic convolutions or dynamic convolutions with upsampling. For regular dynamic convolutions, the dynamic kernels 350 may be stored in a tensor with (k×k) in channel dimension, where (k×k) is the kernel size for the dynamic kernels 350. A dynamic kernel 350 with up-sampling integrated may be stored in a tensor with (k×k×r×r) in channel dimension, where r is upsampling rate. The refinement network 120 may include one upsampling dynamic block in the sequence of M dynamic blocks 123 to produce an upsampled image such as upsampled image 410 in FIG. 4. This upsampling dynamic block can be placed at the first, the last, or anywhere in the sequence of M dynamic blocks. In one embodiment, the upsampling dynamic block is placed as the first block in the sequence. The upsampling dynamic block generates an upsampling dynamic kernel with the channel dimension expanded by r×r; equivalently, this dynamic block generates (r×r) dynamic kernels with each kernel size=k×k. Each of the other dynamic blocks in the sequence of M dynamic blocks 123 may generate a regular dynamic kernel with kernel size=k×k. All of the M dynamic blocks 123 in combination perform super-resolution operations in addition to other image refinement operations such as de-noising and de-blurring.

In a regular dynamic convolution, convolutions are conducted by using dynamic kernels K of kernel size k×k. Such operation can be expressed as:

Iₒᵤₜ(i,j)=Σ_{u=-Δ}^{Δ}Σ_{v=-Δ}^{Δ}K_{i,j}(u,v)·Iᵢₙ(i−u,j−v), (2)

where Iᵢₙ and Iₒᵤₜ represent input and output image, respectively, i and j are the coordinates in an image, u and v are the coordinates in each Ki,j. Note that Δ=floor (k/2). Applying these dynamic kernels is equivalent to computing a weighted sum over nearby pixels to enhance the image quality; different kernels are applied to different grids of the image. In a default setting, there are H×W kernels and the corresponding weights are shared across channels. By introducing an additional dimension C with Equation (2), dynamic convolution can be extended for independent weights across channels.

In a dynamic convolution with upsampling, r×r convolutions are performed on the same corresponding patch to create r×r new pixels, where the patch is the area to which the dynamic kernel is applied. The mathematical form of such operation is defined as:

Iₒᵤₜ(i×r+x,j×r+y)=Σₓ₌₀^{r}Σ_{y=0}^{r}Σ_{u=-Δ}^{Δ}Σ_{v=-Δ}^{Δ}K_{i,j,x,y}(u,v)·Iᵢₙ(i−u,j−v), (3)

where x and y are in the coordination of each r×r output block (0≤x; y≤r−1). Here, the resolution of Iₒᵤₜ is r times the resolution of lin. A total of r²HW kernels are used to generate rH×rW pixels as Iₒᵤₜ. When performing the dynamic convolution with upsampling, the weights may be shared across channels to avoid excessively high dimensionality.

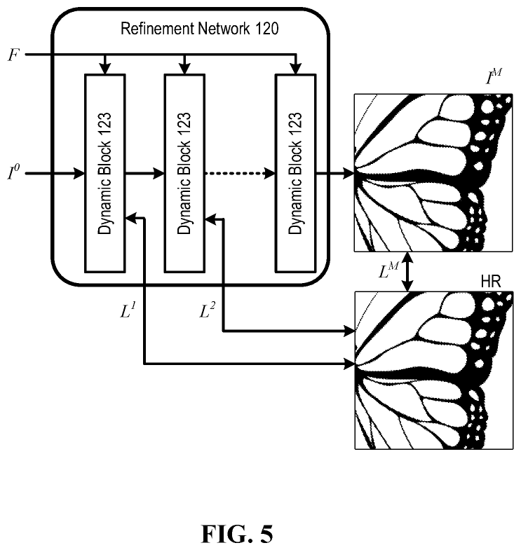

FIG. 5 is a diagram illustrating multistage loss computations according to one embodiment. A multistage loss is computed at the outputs of dynamic blocks. The losses are calculated as a difference metric between the HR image (I_{HR}) and I^{m} at the output of each dynamic blocks 123. When a ground truth image is available, the difference metric measures the difference between the ground truth image and the output of the dynamic block. The loss is computed as:

Loss=Σₘ₌₁^{M}F(I^{m},I_{HR}), (4)

where M is the number of dynamic blocks 123 and F is loss function such as L2 loss or perceptual loss. To obtain a high-quality resultant image, the sum of losses from each dynamic block 123 is minimized. The sum of losses is used to update the convolution weights in each dynamic block 123.

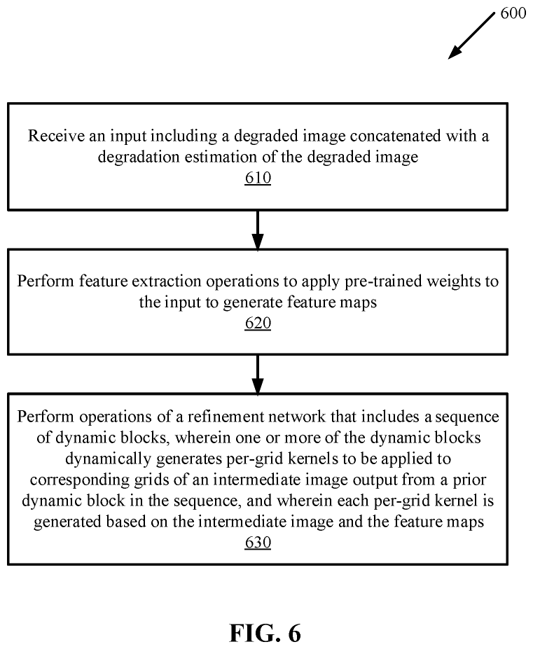

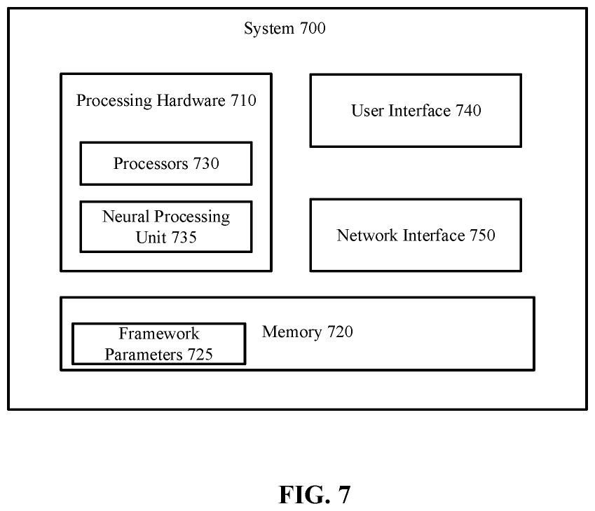

FIG. 6 is a flow diagram illustrating a method 600 for image refinement according to one embodiment. The method 600 may be performed by a computer system; e.g., a system 700 in FIG. 7. The method 600 begins at step 610 when the system receives an input including a degraded image concatenated with a degradation estimation of the degraded image. At step 620, the system performs feature extraction operations to apply pre-trained weights to the input to generate feature maps. At step 630, the system performs operations of a refinement network that includes a sequence of dynamic blocks. One or more of the dynamic blocks dynamically generates per-grid kernels to be applied to corresponding grids of an intermediate image output from a prior dynamic block in the sequence. Each per-grid kernel is generated based on the intermediate image and the feature maps.

FIG. 7 is a block diagram illustrating a system 700 operative to perform image refinement operations including dynamic convolutions according to one embodiment. The system 700 includes processing hardware 710 which further includes one or more processors 730 such as central processing units (CPUs), graphics processing units (GPUs), digital processing units (DSPs), field-programmable gate arrays (FPGAs), and other general-purpose processors and/or special-purpose processors. In one embodiment, the processing hardware 710 includes a neural processing unit (NPU) 735 to perform neural network operations. The processing hardware 710 such as the NPU 735 or other dedicated neural network circuits are operative to perform neural network operations including, but not limited to: convolution, deconvolution, ReLU operations, fully-connected operations, normalization, activation, pooling, resizing, upsampling, element-wise arithmetic, concatenation, etc.

The processing hardware 710 is coupled to a memory 720, which may include memory devices such as dynamic random access memory (DRAM), static random access memory (SRAM), flash memory, and other non-transitory machine-readable storage media; e.g., volatile or non-volatile memory devices. To simplify the illustration, the memory 720 is represented as one block; however, it is understood that the memory 720 may represent a hierarchy of memory components such as cache memory, system memory, solid-state or magnetic storage devices, etc. The processing hardware 710 executes instructions stored in the memory 720 to perform operating system functionalities and run user applications. For example, the memory 720 may store framework parameters 725, which are the trained parameters of the framework 100 (FIG. 1) such as the kernel weights of the CNN layers in the framework 100.

In some embodiments, the memory 720 may store instructions which, when executed by the processing hardware 710, cause the processing hardware 710 to perform image refinement operations according to the method 600 in FIG. 6.

The operations of the flow diagram of FIG. 6 have been described with reference to the exemplary embodiment of FIG. 7. However, it should be understood that the operations of the flow diagram of FIG. 6 can be performed by embodiments of the invention other than the embodiment of FIG. 7 and the embodiment of FIG. 7 can perform operations different than those discussed with reference to the flow diagram. While the flow diagram of FIG. 6 shows a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A method for image refinement, comprising:
receiving an input including a degraded image concatenated with a degradation estimation of the degraded image;
performing feature extraction operations to apply pre-trained weights to the input to generate feature maps; and
performing operations of a refinement network that includes a sequence of dynamic blocks, wherein one or more of the dynamic blocks dynamically generates per-grid kernels to be applied to corresponding grids of an intermediate image output from a prior dynamic block in the sequence, and wherein each per-grid kernel is generated based on the intermediate image and the feature maps.

2. The method of claim 1, wherein each of the one or more dynamic blocks includes a first path of a convolutional layer that operates on the intermediate image and the feature maps to generate a corresponding per-grid kernel, and a second path of convolutional layers that operate on the intermediate image and the feature maps to generate a residual image.

3. The method of claim 2, further comprising:
performing pixel-wise additions on an output of the first path and an output of the second path.

4. The method of claim 1, wherein a first dynamic block in the sequence dynamically generates a per-grid kernel to be applied to corresponding grids of the degraded image.

5. The method of claim 1, wherein the degraded image is a low-resolution image and the refinement network performs super-resolution operations to output a high-resolution image.

6. The method of claim 1, wherein performing feature extraction operations further comprises:
performing operations of residual blocks, each residual block including convolution layers and a Rectified Linear Units (ReLU) layer.

7. The method of claim 1, wherein performing the operations of the refinement network further comprises:
generating, by a dynamic block, an upsampling dynamic kernel with a channel dimension expanded by r×r, where r is an upsampling rate; and
convolving the upsampling dynamic kernel with an input image to the dynamic block to upsample the input image by r×r.

8. The method of claim 1, wherein each dynamic block is trained by a difference metric which measures a difference between a ground truth image and an output of the dynamic block.

9. The method of claim 1, wherein the degradation estimation indicates degradations in different regions of the degraded image, the degradation in each region including one or more of: downsampling, blur, and noise.

10. The method of claim 1, wherein each corresponding grid contains one or more image pixels sharing and using a same per-grid kernel.

11. A system comprising:
memory to store parameters of a feature extraction network and a refinement network;
processing hardware coupled to the memory, the processing hardware operative to:
receive an input including a degraded image concatenated with a degradation estimation of the degraded image;
perform operations of the feature extraction network to apply pre-trained weights to the input to generate feature maps; and
perform operations of the refinement network that includes a sequence of dynamic blocks, wherein one or more of the dynamic blocks dynamically generates per-grid kernels to be applied to corresponding grids of an intermediate image output from a prior dynamic block in the sequence, and wherein each per-grid kernel is generated based on the intermediate image and the feature maps.

12. The system of claim 11, wherein each of the one or more dynamic blocks includes a first path of a convolutional layer that operates on the intermediate image and the feature maps to generate a corresponding per-grid kernel, and a second path of convolutional layers that operate on the intermediate image and the feature maps to generate a residual image.

13. The system of claim 12, the processing hardware is further operative to:
perform pixel-wise additions on an output of the first path and an output of the second path.

14. The system of claim 11, wherein a first dynamic block in the sequence dynamically generates a per-grid kernel to be applied to corresponding grids of the degraded image.

15. The system of claim 11, wherein the degraded image is a low-resolution image and the refinement network performs super-resolution operations to output a high-resolution image.

16. The system of claim 11, wherein the processing hardware is further operative to:
perform operations of residual blocks in the feature extraction network, each residual block including convolution layers and a Rectified Linear Units (ReLU) layer.

17. The system of claim 11, wherein the processing hardware is further operative to:
generate, by a dynamic block, an upsampling dynamic kernel with a channel dimension expanded by r×r, where r is an upsampling rate; and
convolve the upsampling dynamic kernel with an input image to the dynamic block to upsample the input image by r×r.

18. The system of claim 11, wherein each dynamic block is trained by a difference metric which measures a difference between a ground truth image and an output of the dynamic block.

19. The system of claim 11, wherein the degradation estimation indicates degradations in different regions of the degraded image, the degradation in each region including one or more of: downsampling, blur, and noise.

20. The system of claim 11, wherein each corresponding grid contains one or more image pixels sharing and using a same per-grid kernel.
